(19) United States
(12) Patent Application Publication
(10) Pub. No.: US 2008/0320072 A1
(43) Pub. Date: Dec. 25, 2008

(54) INFORMATION PROCESSING SYSTEM AND METHOD, INFORMATION PROCESSING APPARATUS AND METHOD, AND PROGRAM

(75) Inventors: Ryuhei SAKANOUE, Tokyo (JP); Tetsujiro Kondo, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/129,301

(22) Filed: May 29, 2008

(30) Foreign Application Priority Data
Jun. 22, 2007 (JP) 2007-164963

(51) Int. Cl. G06F 15/16

(52) U.S. Cl. 709/202

(57) ABSTRACT

A system includes first and second information processing apparatuses. The first apparatus: performs processing on each of a plurality of local area data using a processing scheme, the data being obtained by dividing an input signal, the processing scheme being selected from processing schemes, respectively; and outputs an output signal containing local area processing result data as each the processed result and not containing information on the processing schemes used on each local area processing result. The second apparatus: extracts the local area processing result data from the output signal of the first apparatus, estimates each processing scheme used for the processing on each extracted local area processing result data, and reconstructs each local area data corresponding thereto on the basis of the estimated processing scheme, and reconstructs the input signal of the first apparatus by combining each the reconstructed local area data.

### CROSS-REFERENCE TO RELATED APPLICATIONS

The present application claims benefit of priority of Japanese patent Application No. 2007-164963 filed in the Japanese Patent Office on Jun. 22, 2007, the entire disclosure of which is incorporated herein by reference.

### BACKGROUND OF THE INVENTION

1. Field of the Invention

The present invention relates to an information processing system and method, an information processing apparatus and method, and a program.

2. Description of Related Art

In Japanese Unexamined Patent Application Publication No. H02-70127 (Patent Document 1), an adaptive switching encoding technique, which switches encoding schemes (base and quantization) for each block (local area), is disclosed.

### SUMMARY OF THE INVENTION

In the technique disclosed in the Patent Document 1, the volume of information on the fact that switching has been made is essential, and hence an issue arises that efficiency is decreased by the processing of the information.

Such an issue is encountered in a known all adaptive processing, in which a plurality of local areas separated and divided from an input signal is performed processing on each of the plurality of local areas using the respective processing schemes selected from a plurality of processing schemes. This is because even in other known adaptive processing, processing scheme information for specifying processing schemes used for the processing is anyway essential for all of a plurality of local areas.

Accordingly, it is desirable to enable a reduction of the volume of information about adaptive processing results.

In accordance with a first aspect of the present invention, there is provided an information processing system which includes a first information processing apparatus and a second information processing apparatus. The first information processing apparatus performs processing on each of a plurality of local area data using a processing scheme, respectively, the plurality of local area data being obtained by dividing an input signal, the processing scheme being selected from a plurality of processing schemes, respectively, and outputs an output signal containing a plurality of local area processing result data obtained as each the processed result and not containing information on the processing schemes used to each of the plurality of local area processing result data. The second information processing apparatus extracts the plurality of local area processing result data from the output signal of the first information processing apparatus, estimates each of the processing schemes used for the processing on each of the plurality of extracted local area processing result data, and reconstructs each of the plurality of local area data corresponding thereto on the basis of the estimated processing schemes, respectively, and reconstructs the input signal of the first information processing apparatus by combining each the reconstructed local area data.

In accordance with a second aspect of the present invention, there is provided an information processing method for an information processing system, which is a method corresponding to the information processing system according to the first aspect of the present invention.

According to the first and second aspects of the present invention, the following processing is performed between the first information processing apparatus and the second information processing apparatus. Namely, in the first information processing apparatus, processing on each of a plurality of local area data obtained by dividing an input signal are performed using a processing scheme, and the processing scheme being selected from a plurality of processing schemes, respectively. Then, an output signal containing a plurality of local area processing result data obtained as each of the processed result and not containing information on the processing schemes used on each of the plurality of local area processing result data is outputted from the first information processing apparatus. In the second information processing apparatus, the plurality of local area processing result data are extracted from the output signal of the first information processing apparatus, each of the processing schemes used for the processing is estimated for each of the plurality of extracted local area processing result data, and each of the plurality of local area data corresponding thereto is reconstructed on the basis of the estimated each estimated processing scheme. Then, by combining each the reconstructed local area data, the input signal of the first information processing apparatus is reconstructed.

In accordance with a third aspect of the present invention, there is provided a first information processing apparatus which includes processing execution means for performing processing on each of a plurality of local area data using a processing scheme, respectively, the plurality of local area data being obtained by dividing an input signal, the processing scheme being selected from a plurality of processing scheme, respectively; and output signal generating means for generating an output signal containing a plurality of local area processing result data obtained as each the processed result by the processing performing means and not containing information on the processing schemes used to each of the plurality of local area processing result data.

The local area data may include a property establishing a predetermined correlation at a boundary plane with another local area data.

If the plurality of local area data is reconstructed from the output signal of the information processing apparatus utilizing the property, in another information processing apparatus, the information processing apparatus may further include encryption means for encrypting only a predetermined part of all data necessary for reconstructing the plurality of local area data in the another information processing apparatus.

In accordance with a fourth aspect of the present invention, there are provided an information processing method and a program, which are a method and a program corresponding to the information processing apparatus according to the third aspect of the present invention.

According to the third and fourth aspects of the present invention, there is provided an information processing method and a computer, includes the steps of: performing processing on each of a plurality of local area data using a processing scheme, respectively, the plurality of local area data being obtained by dividing an input signal, the processing scheme being selected from a plurality of processing schemes, respectively; and generating an output signal containing a plurality of local area processing result data obtained as each the processed result and not containing information on the processing schemes used on each of the plurality of local area processing result data.

In accordance with a fifth aspect of the present invention, there is provided an information processing apparatus which reconstructs an input signal from an output signal of an another information processing apparatus, the input signal being reconstructed from an output signal of the another information processing apparatus, including if the another information processing apparatus: performs processing on each of a plurality of local area data using a processing scheme, respectively, the plurality of local area data being obtained by dividing an input signal, the processing scheme being selected from a plurality of processing schemes, respectively; and

outputs an output signal containing a plurality of local area processing result data as each the processed result and not containing information on the processing schemes used to each of the plurality of local area processing result data, extracting means for extracting the plurality of local area processing result data from the output signal of the another information processing apparatus; local area reconstructing means for estimating each of the processing schemes used for the processing on each of the plurality of local area processing result data extracted by the extracting means, and
reconstructing each of the plurality of local area data corresponding thereto on the basis of the estimated processing schemes, respectively; and combining means for combining the local area data each reconstructed by the local area reconstructing means to reconstruct the input signal of the another information processing apparatus.

The local area data may have a property establishing a predetermined correlation at a boundary plane with another local area data. The local area reconstructing means estimates, by using the property, the processing schemes used for the local area processing result data to be processed.

If the another information processing apparatus further encrypts only a predetermined part of all data necessary for reconstructing the plurality of local area data in the information processing apparatus, and transmits the output signal containing the encrypted data obtained thereby, the extracting means further extracts the encrypted data from the output signal of the another information processing apparatus, the information processing apparatus may further include decryption means for decrypting the encrypted data, and the local area reconstructing means may further use data obtained as a result of the decryption by the decryption means, in the estimation processing of the processing schemes.

In accordance with a sixth aspect of the present invention, there is provided an information processing method and a program, which correspond to the information processing apparatus according to fifth aspect of the present invention.

According to the sixth aspect of the present invention, the following processing is performed by an information processing apparatus or a computer that reconstructs an input signal to another information processing apparatus, from an output signal from the another information processing apparatus, if the another information processing apparatus: performs processing on a plurality of local area data using a processing scheme, respectively, the plurality of local area data being obtained by dividing an input signal, the processing scheme being selected from a plurality of processing scheme, respectively, and outputs an output signal containing a plurality of local area processing result data obtained as each the processed result and not containing information on the processing schemes used to each of the plurality of local area processing result data. Namely, the plurality of local area processing result data from the output signal of the another information processing apparatus are extracted, and each of the processing schemes used for the processing on each of the plurality of extracted local area processing result data are estimated, and each of the plurality of local area data corresponding thereto on the basis of the estimated processing schemes are reconstructed. As a result, by combining the plurality of reconstructed local area data, the input signal of the another information processing apparatus is reconstructed.

As described above, according to embodiments of the present invention, adaptive processing can be implemented, in which processing on each of a plurality of local areas are performed using a processing scheme, respectively, the plurality of local area being obtained by dividing an input signal, the processing scheme being selected from a plurality of processing schemes, respectively. Particularly, the volume of information on the adaptive processing results can be reduced.

The above summary of the present invention is not intended to describe each illustrated embodiment or every implementation of the present invention. The figures and the detailed description which follow more particularly exemplify these embodiments.

### BRIEF DESCRIPTION OF DRAWINGS

FIG. 1 is a functional block diagram showing a functional configuration example of an information processing system that performs a known adaptive encoding/decoding processing;

FIG. 2 is a functional block diagram showing a detailed functional configuration example of an adaptive encoder of FIG. 1;

FIG. 3 is a functional block diagram showing a detailed functional configuration example of an adaptive decoder of FIG. 1;

FIG. 4 is a functional block diagram showing a functional configuration example of an information processing system according to an embodiment to which the present invention is applied;

FIG. 5 is a functional block diagram showing a detailed functional configuration example of an adaptive encoder of FIG. 4;

FIG. 6 is a flowchart for illustrating an example of adaptive encoding processing by the adaptive encoder of FIG. 5;

FIG. 7 is a functional block diagram showing a detailed functional configuration example of an adaptive scheme estimation decoder of FIG. 4;

FIG. 8 is a flowchart for illustrating an example of adaptive scheme estimation decoding processing by the adaptive scheme estimation decoder of FIG. 7;

FIG. 9 is a diagram specifically illustrating an example of the adaptive scheme estimation decoding processing of FIG. 8;

FIG. 10 is a diagram specifically illustrating an example of the adaptive scheme estimation decoding processing of FIG. 8;

FIG. 11 is a functional block diagram showing a functional configuration example of the information processing system according to the embodiment to which the present invention is applied, the example being different from that of FIG. 4;

FIG. 12 is a functional block diagram showing a detailed functional configuration example of an adaptive encoding/decoding guaranteeing section of FIG. 11;

FIG. 13 is a flowchart for illustrating an example of adaptive encoding processing by the adaptive encoding/decoding guaranteeing section of FIG. 12;

FIG. 14 is a functional block diagram showing a functional configuration example of the information processing system according to the embodiment to which the present invention is applied, the example having an encrypting section added to the configuration of FIG. 4;

FIG. 15 is a functional block diagram showing a functional configuration example of the information processing system according to the embodiment to which the present invention is applied, the example having an encrypting section added to the configuration of FIG. 11; and

FIG. 16 is a block diagram showing a configuration of a personal computer being an example of a hardware resource that executes software when an embodiment of the present invention is implemented by the software.

### DETAILED DESCRIPTION OF EMBODIMENTS

Embodiments of the present invention will be described below. The constituent features of an embodiment of the present invention correspond, by way of example, to specific examples described in the present specification or the drawings as follows. This description is to confirm that the specific examples supporting the present invention are described in the present specification or the drawings. Therefore, even if there is a specific example which is described in the present specification or the drawings but not described therein as the specific example corresponding to constituent features of an embodiment the present invention, this does not mean that the specific example does not correspond to the constituent features of an embodiment of the present invention. Conversely, even if a specific example is described herein as corresponding to constituent features, this does not mean that the specific example does not correspond to any constituent feature other than the constituent feature.

Furthermore, this description does not mean that all inventions corresponding to specific examples described in the present specification or the drawings are claimed. In other words, this description does not deny the presence of inventions corresponding to specific examples described in the present specification or the drawings but not claimed in the present application, i.e., the presence of inventions that will be included in an application filed as a divisional application, or will be added due to amendments in the future.

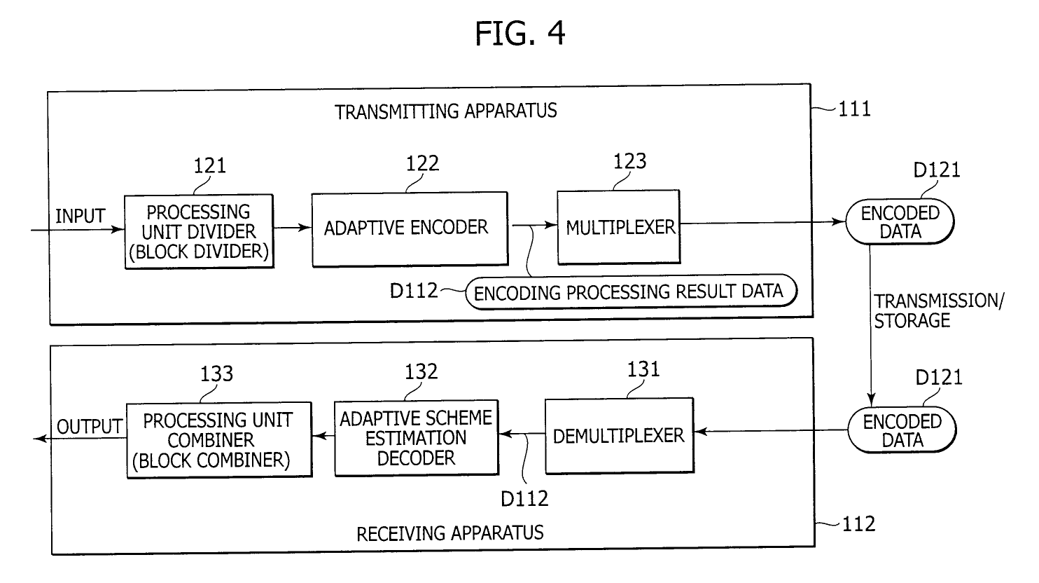

An information processing system according to a first embodiment of the present invention includes: a first information processing apparatus (e.g., a transmitting apparatus 111 of FIG. 4) and a second information processing apparatus (e.g., a receiving apparatus 112 of FIG. 4). The first information processing apparatus performs processing (e.g., processing by an adaptive encoder 122 of FIG. 4) for each of a plurality of local area data (e.g., processing unit data such as blocks from a processing unit divider 121 of FIG. 4) using a processing scheme, respectively, the plurality of local area data being obtained by dividing an input signal, the processing scheme being selected from a plurality of processing schemes, respectively, and outputs an output signal (e.g., encoded data D121 of FIG. 4) containing a plurality of local area processing result data (e.g., processing by a multiplexer 123 of FIG. 4) obtained as each the processed result and not containing information on the processing schemes used to each of the plurality of local area processing result data. The second information processing apparatus extracts the plurality of local area processing result data from the output signal of the first information processing apparatus (e.g., processing by a demultiplexer 131 of FIG. 4), estimates each of the processing schemes used for the processing on each of the plurality of extracted local area processing result data, and reconstructs each of the plurality of local area data corresponding thereto on the basis of the estimated processing schemes, respectively, (e.g., processing by an adaptive scheme estimation decoder 132 of FIG. 4) and reconstructs the input signal of the first information processing apparatus by combining each the reconstructed local area data (e.g., processing by a processing unit combiner 133 of FIG. 4).

A first information processing apparatus (e.g., the transmitting apparatus 111 of FIG. 4) according to an embodiment of the present invention, which includes processing execution means (e.g., the adaptive encoder 122 of FIG. 4) for performing processing on each of a plurality of local area data (e.g., processing unit data such as blocks from the processing unit divider 121 of FIG. 4) using a processing scheme, respectively, the plurality of local area data being obtained by dividing an input signal, the processing scheme being selected from a plurality of processing scheme, respectively; and output signal generating means (e.g., the multiplexer 123 of FIG. 4) for generating an output signal (e.g., the encoded data D121 of FIG. 4) containing a plurality of local area processing result data obtained as each the processed result by the processing performing means and not containing information on the processing schemes used to each of the plurality of local area processing result data.

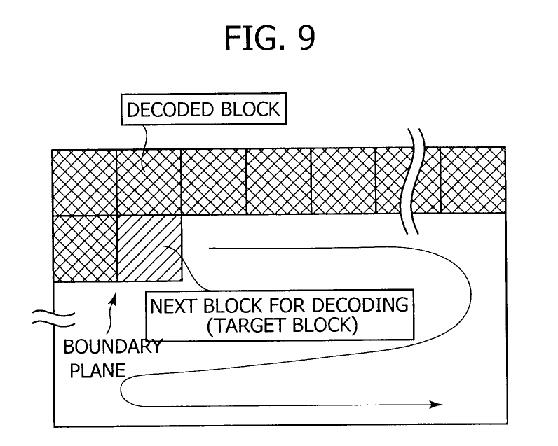

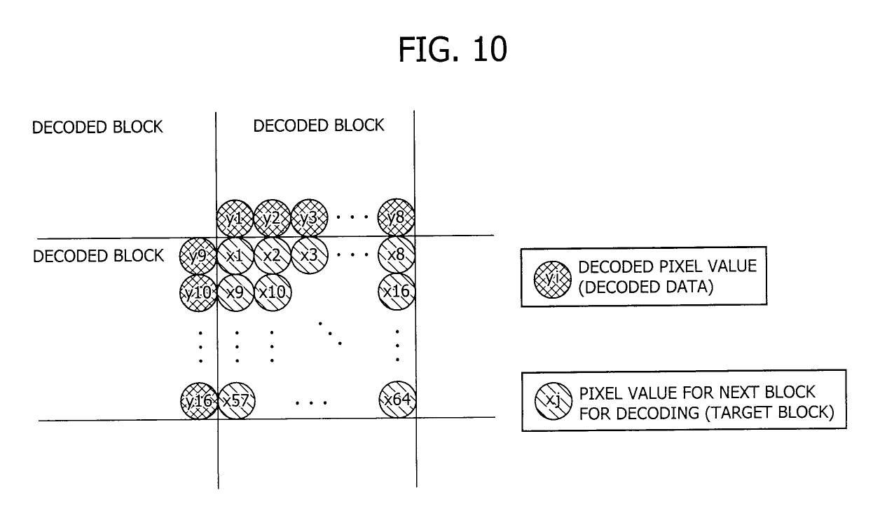

The local area data has a property (e.g., a property of FIGS. 9 and 10 as to image data) establishing a predetermined correlation at a boundary plane with another local area data.

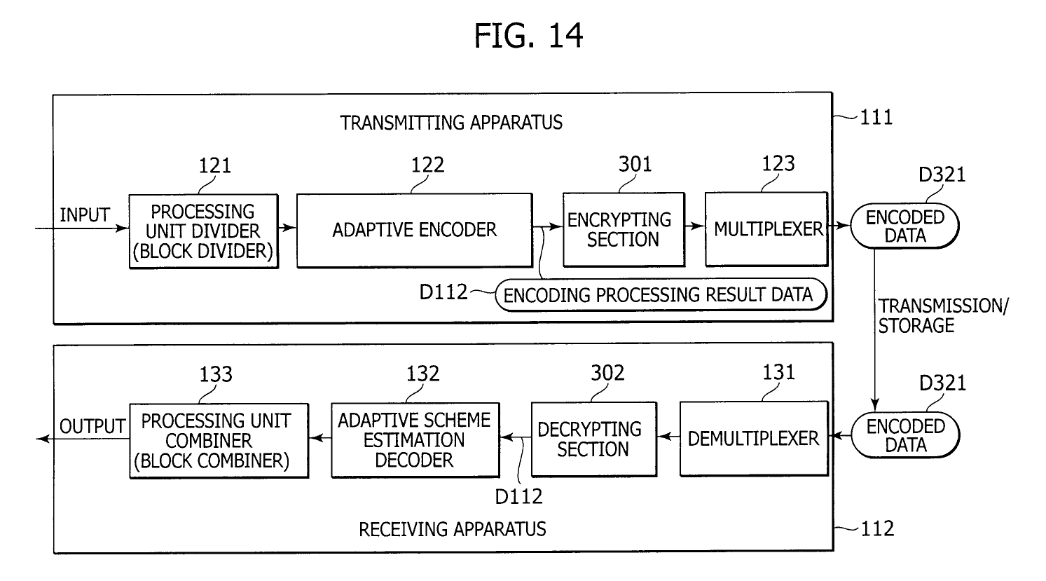

In another information processing apparatus, if the plurality of local area data is reconstructed from the output signal of the information processing apparatus utilizing the property, in another information processing apparatus, the information processing apparatus further includes encryption means (e.g., an encrypting section 301 of FIG. 14) for encrypting only a predetermined part of all data necessary for reconstructing the plurality of local area data in the another information processing apparatus.

An information processing apparatus (e.g., the receiving apparatus 112 of FIG. 4) according to an embodiment of the present invention, which reconstructs an input signal from an output signal of an another information processing apparatus, the input signal being reconstructed from an output signal of the another information processing apparatus, including:

if the another information processing apparatus:

performs processing on each of a plurality of local area data using a processing scheme, respectively, the plurality of local area data being obtained by dividing an input signal, the processing scheme being selected from a plurality of processing schemes, respectively, and

outputs an output signal (e.g., the encoded data D121 of FIG. 4) containing a plurality of local area processing result data as each the processed result and not containing information on the processing schemes used to each of the plurality of local area processing result data,

extracting means (e.g., the demultiplexer 131 of FIG. 4) for extracting the plurality of local area processing result data from the output signal of the another information processing apparatus;

local area reconstructing means (e.g., the adaptive scheme estimation decoder 132 of FIG. 4) for estimating each of the processing schemes used for the processing on each of the plurality of local area processing result data extracted by the extracting means, and reconstructing each of the plurality of local area data corresponding thereto on the basis of the estimated processing schemes, respectively; and

combining means (e.g., the processing unit combiner 133 of FIG. 4) for combining the local area data each reconstructed by the local area reconstructing means to reconstruct the input signal of the another information processing apparatus.

The local area data has a property (e.g., the property of FIGS. 9 and 10 as to image data) establishing a predetermined correlation at a boundary plane with another local area data, and the local area reconstructing means estimates, by using the property, the processing schemes used on the local area processing result data to be processed.

If the another information processing apparatus further encrypts only a predetermined part of all data necessary for reconstructing the plurality of local area data in the information processing apparatus, and transmits the output signal containing the encrypted data obtained thereby, the extracting means further extracts the encrypted data from the output signal of the another information processing apparatus, the information processing apparatus further includes decryption means (e.g., a decrypting section 302 of FIG. 14) for decrypting the encrypted data, and the local area reconstructing means further uses data obtained as a result of the decryption by the decryption means, in the estimation processing of the processing schemes.

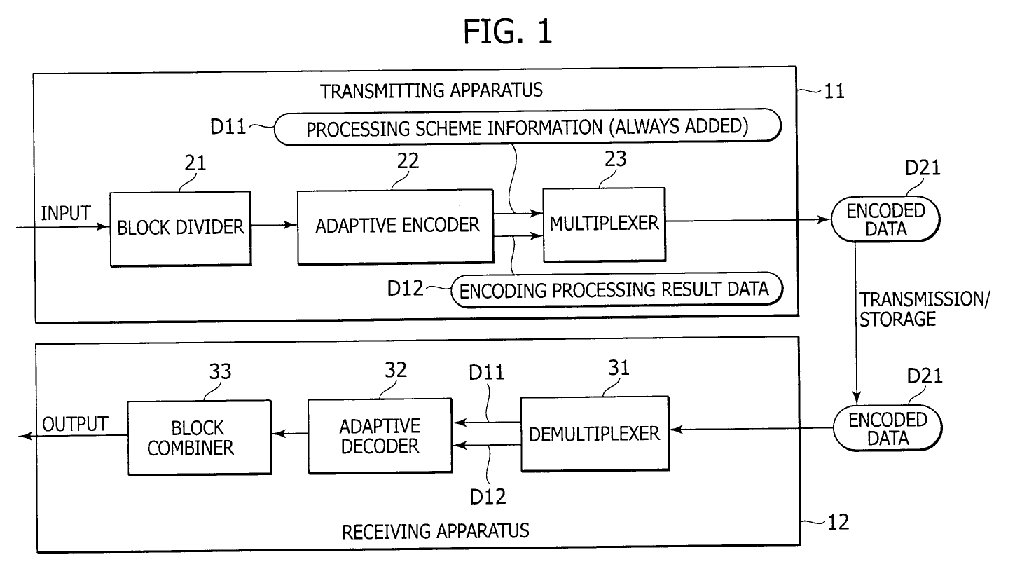

Then, for ease of understanding of the present invention, a known adaptive encoding processing, and adaptive decoding processing corresponding thereto will be described with reference to FIGS. 1 to 3 as a representative example of a known adaptive signal processing.

It is noted that an apparatus for outputting data (hereinafter called “encoded data”) including processing result data obtained by adaptive encoding processing is hereinafter called a transmitting apparatus for convenience. Meanwhile an apparatus for having the encoded data inputted thereto and performing decoding processing on the encoded data is called a receiving apparatus, for convenience.

Furthermore, in all functional block diagrams including FIGS. 1 to 3, rectangular blocks show functional blocks into which the transmitting apparatus or the receiving apparatus is classified by function. Meanwhile, elliptic figures indicate predetermined data. Furthermore, any important data to be processed by the transmitting apparatus or the receiving apparatus is prefixed with “D” in order to clarify that it is data, not a component of the apparatus.

The transmitting apparatus 11 includes a block divider 21 to a multiplexer 23.

The block divider 21 receives a predetermined image signal as an input signal, divides the input signal into a plurality of blocks, and supplies these blocks to an adaptive encoder 22.

The adaptive encoder 22 performs adaptive encoding processing in which each block is a unit of the processing. Namely, the adaptive encoder 22 assigns the blocks for processing as target blocks one after another, and performs the adaptive encoding processing on these target blocks.

The adaptive encoding processing includes, e.g., processing in which a transform scheme and a quantization scheme suitable for a target block are selected from among a plurality of kinds of transform schemes and a plurality of kinds of quantization schemes, and encoding processing is performed on the target block using the selected transform scheme and quantization scheme. This is because encoding efficiency is expected to improve by adopting such adaptive encoding processing.

It is noted that data obtained as results of such adaptive encoding processing performed on the target block is hereinafter denoted “encoding processing result data”. According to this denotation, encoding processing result data D12 is outputted from the adaptive encoder 22, and inputted to the multiplexer 23.

In this case, to reconstruct the encoding processing result data D12, i.e., to put the data back to a state of the target block before compression, one needs to know which transform scheme and quantization scheme were applied thereto. Consequently, information D11 (hereinafter called “processing scheme information”) indicative of which transform scheme and quantization scheme are applied is also outputted from the adaptive encoder 22, and inputted to the multiplexer 23.

The multiplexer 23 processes the encoding processing result data D12 sequentially outputted from the adaptive encoder 22 into stream data by association with processing scheme information D11, and outputs the stream data as encoded data D21.

This encoded data D21 is supplied to the receiving apparatus 12 in a form (transmission) involving transmission over a network or the like, or in a form (storage) involving a recording medium on which the encoded data D21 is recorded.

The receiving apparatus 12 includes a demultiplexer 31 to a block combiner 33.

The demultiplexer 31 separates the encoding processing result data D12 from the associated processing scheme information D11 in the encoded data D21, and supplies the encoding processing result data to an adaptive decoder 32.

The adaptive decoder 32 specifies the transform scheme and the quantization scheme used for the encoding processing result data D12, on the basis of the processing scheme information D11. The adaptive decoder 32 then performs, on the encoding processing result data D12, decoding processing using an inverse transform scheme for the specified transform scheme and an inverse quantization scheme for the specified quantization scheme. As a result, the original block (the target block to be processed in the adaptive encoder 22) is reconstructed, and the reconstructed target block is supplied from the adaptive decoder 32 to the block combiner 33.

The block combiner 33 reconstructs an image signal which is the input signal of the transmitting apparatus 11 by combining each block reconstructed by the adaptive decoder 32, and outputs the image signal as an output signal.

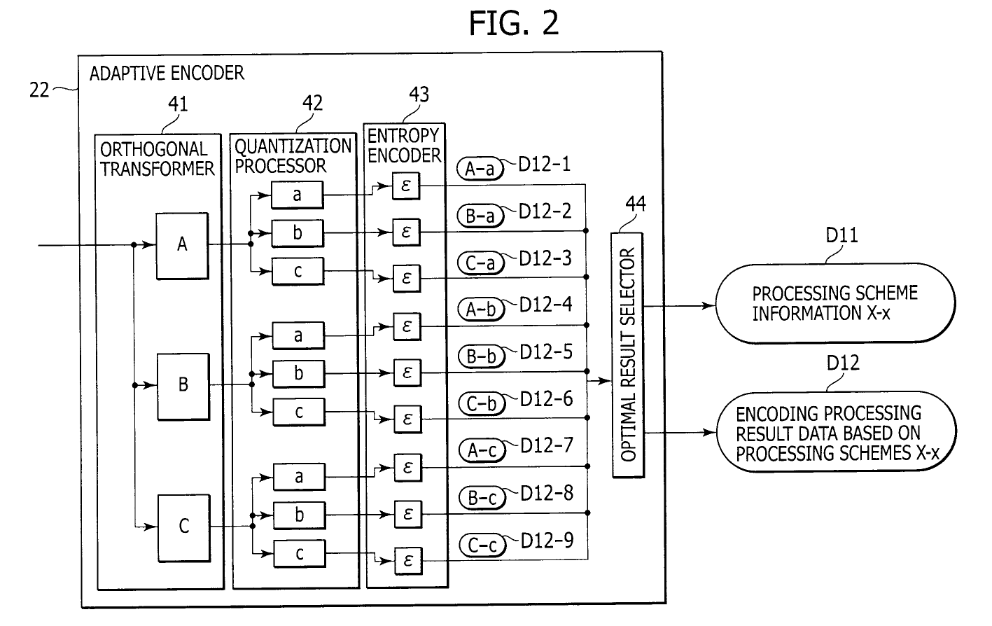

FIG. 2 is a functional block diagram showing a configuration example of a known adaptive encoder 22.

The adaptive encoder 22 in FIG. 2 includes an orthogonal transformer 41, a quantization processor 42, an entropy encoder 43, and an optimal result selector 44.

Namely, the encoding processing by the adaptive encoder 22 includes a series of processing, i.e., orthogonal transform processing by the orthogonal transformer 41, quantization processing by the quantization processor 42, and entropy encoding processing by the entropy encoder 43.

The orthogonal transformer 41 performs the orthogonal transform processing on a target block using each of various transform schemes such as DCT (Discrete Cosine Transform), DST (Discrete Sine Transform), and DWT (Discrete Wavelet Transform). In the example of FIG. 2, small blocks inside the orthogonal transformer 41 indicate that three kinds of transform schemes A, B, C are adopted.

The quantization processor 42 performs the quantization processing using each of various quantization schemes on each of three data items (the target block after the orthogonal transform) on which the orthogonal transform processing using the three kinds of transform schemes A, B, C has been performed. In the example of FIG. 2, small blocks inside the quantization processor 42 indicate that three kinds of quantization schemes a, b, c are adopted.

Namely, in the example of FIG. 2, the three kinds of transform schemes A, B, C are adopted, and the three kinds of quantization schemes a, b, c are adopted. As a result, nine (3×3) encoding processing result data items D12-1 to D12-9 are obtained as a combination of these schemes.

Then, the optimal result selector 44 selects one of the nine encoding processing result data items D12-1 to D12-9 which exhibits the highest encoding efficiency, and outputs the selected data item as the encoding processing result data D12. In doing so, processing scheme information indicative of a transform scheme X (X is any of A to C in the example of FIG. 2) and a quantization scheme x (x is any of a to c in the example of FIG. 2) both used for that encoding processing result data D12 is outputted from the optimal result selector 44.

It is noted that a combination of the transform scheme X and the quantization scheme x is hereinafter denoted “processing schemes X-x”. Namely, according to this denotation, the processing scheme information D11 is information that can specify the processing schemes X-x.

The adaptive encoder 22 of FIG. 2 is merely an example shown for ease of understanding of the known adaptive encoding processing. Namely, the processing schemes in the adaptive encoding processing are not limited to the example of FIG. 2. However, even if any processing scheme is adopted, in the previously known technique, encoding processing result data is outputted together with processing scheme information that can specify the processing scheme for that data.

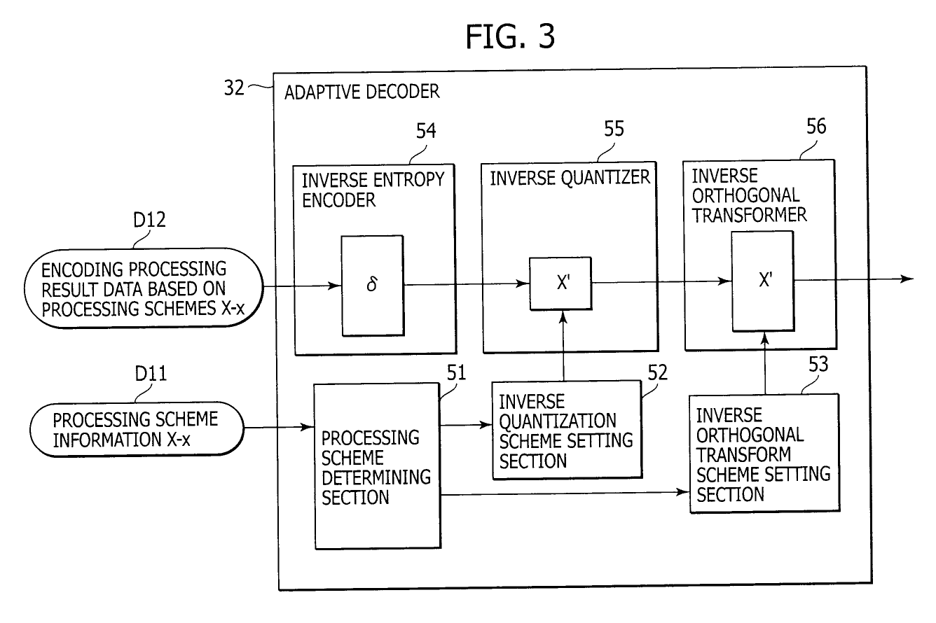

For the known adaptive encoder 22 having the configuration of FIG. 2, the known adaptive decoder 32 has a functional configuration shown in, e.g., FIG. 3. The adaptive decoder 32 of FIG. 3 includes a processing scheme determining section 51 to an inverse orthogonal transformer 56.

The adaptive decoder 32 has the encoding processing result data D12 inputted thereto, and also has the processing scheme information D11 indicative of the processing schemes X-x used for the adaptive encoding processing thereon, inputted thereto.

The processing scheme determining section 51 determines an inverse quantization scheme x′ corresponding to the quantization scheme x specified from the processing scheme information D11, and notifies an inverse quantization scheme setting section 52 of the determined scheme. The inverse quantization scheme setting section 52 sets the inverse quantization scheme x′ notified, to an inverse quantizer 55.

Furthermore, the processing scheme determining section 51 determines an inverse transform scheme X′ corresponding to the transform scheme X specified from the processing scheme information D11, and notifies an inverse orthogonal transform scheme setting section 53 of the determined scheme. The inverse orthogonal transform scheme setting section 53 sets the inverse transform scheme X′ notified, to the inverse transformer 56.

An inverse entropy encoder 54 performs inverse entropy encoding processing on the encoding processing result data D12, and supplies processing result data obtained thereby to the inverse quantizer 55. The inverse quantizer 55 performs inverse quantization processing on the processing result data from the inverse entropy encoder 54 using the inverse quantization scheme x′ set by the inverse quantization scheme setting section 52, and supplies processing result data obtained thereby to the inverse orthogonal transformer 56. The inverse orthogonal transformer 56 performs inverse orthogonal transform processing on the processing result data from the inverse quantizer 55 using the inverse orthogonal transform scheme X′ set by the inverse orthogonal transform scheme setting section 53. As a result, the target block is reconstructed, and the reconstructed target block is outputted as a decoded result by the adaptive decoder 32.

As described above, for the encoded data D21 outputted from the known transmitting apparatus 11, the processing scheme information D11 is adopted as added information indicative of what encoding processing has been performed. It has been essentially required that this processing scheme information D11 be added to the encoding processing result data D12 for all blocks. Thus, compression efficiency for the encoded data D21 may decreases by the volume of the processing scheme information D11 for all the blocks. Namely, the issue stated earlier arises.

This issue arises not only in the examples of FIGS. 1 to 3 described above, but also similarly even if other processing units are adopted. This is because processing scheme information has always been added for each processing unit in the previously existing technology.

Thus, in order to enhance compression efficiency by reducing added data such as the processing scheme information D11 or the like, the present invention has been made. Referring now to FIG. 4 and forward, an embodiment of the present invention will be described below.

FIG. 4 shows a functional configuration example of an information processing system according to an embodiment to which the present invention is applied.

The information processing system in the example of FIG. 4 includes a transmitting apparatus 111 and a receiving apparatus 112.

The transmitting apparatus 111 includes a processing unit divider 121, an adaptive encoder 122, and a multiplexer 123.

The transmitting apparatus 111 performs adaptive encoding processing to an input signal by each predetermined processing unit, processes processing unit-based encoding processing result data D112 into stream data, and outputs resultant stream data as encoded data D121.

In this case, the transmitting apparatus 111 may adopt an arbitrary processing unit. However, for ease of comparison with the known technique, it is supposed that a block is adopted as the processing unit in the transmitting apparatus 111. If the processing is performed in units of blocks, the processing unit divider 121 and the multiplexer 123 can have functions and configurations similar to those of the block divider 21 and the multiplexer 23 of FIG. 1 in the known technique, respectively.

Accordingly, the main difference between the transmitting apparatus 111 according to an embodiment of the present invention and the transmitting apparatus 11 of FIG. 1 according to the known technique is as follows.

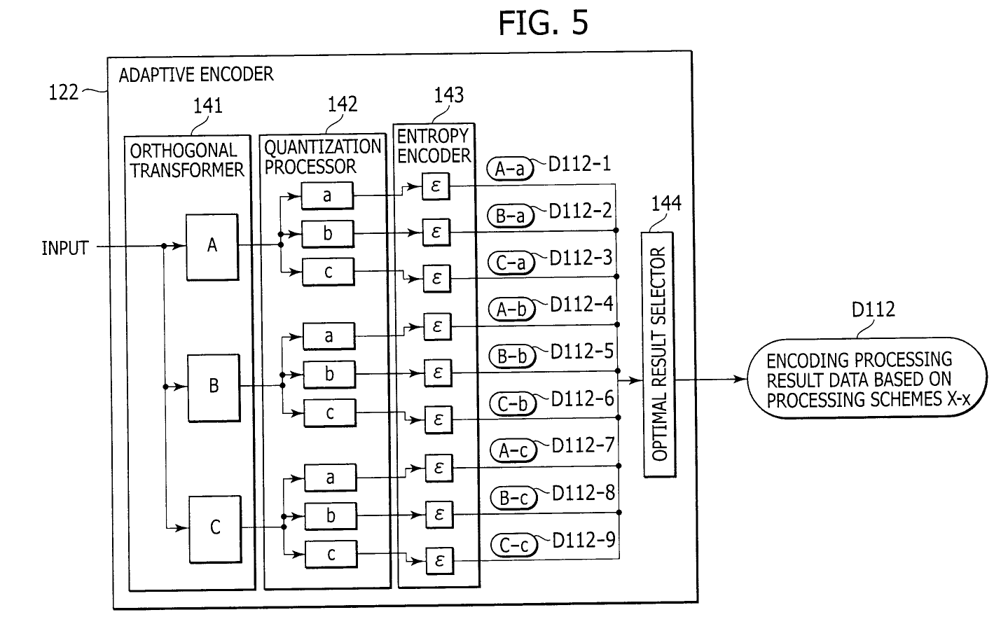

Namely, the known adaptive encoder 22 has consecutively outputted processing scheme information D11 merely being added data to block-based encoding processing result data D12 whenever it outputs the encoding processing result data D12. Conversely, the adaptive encoder 122 according to an embodiment of the present invention only outputs block-based encoding processing result data D112, and does not output any added data such as the processing scheme information D11 essentially required in the known technique, whatsoever. A detailed configuration example of the adaptive encoder 122 according to an embodiment of the present invention will be described later with reference to FIG. 5.

As a result, the encoded data D121 outputted from the transmitting apparatus 111 according to an embodiment of the present invention does not include any added data such as the processing scheme information D11 being essential data in the known technique, at all. Consequently, in comparison with the encoded data D21 outputted from the transmitting apparatus 11 according to the known technique, i.e., the encoded data D21 containing all the block-based processing scheme information D11, the encoded data D121 outputted from the transmitting apparatus 111 according to an embodiment of the present invention has the data volume reduced by the volume of the block-based processing scheme information D11. Namely, it becomes possible to enhance compression efficiency compared with that in the known technique.

In order to perform decoding processing in response to such encoded data D121, the receiving apparatus 112 according to an embodiment to which the present invention is applied includes a demultiplexer 131, an adaptive scheme estimation decoder 132, and a processing unit combiner 133.

In the present embodiment, since the block unit is adopted as the processing unit as described above, the demultiplexer 131 and the processing unit combiner 133 can have functions and configurations similar to those of the demultiplexer 31 and the block combiner 33 of FIG. 1 according to the known technique, respectively.

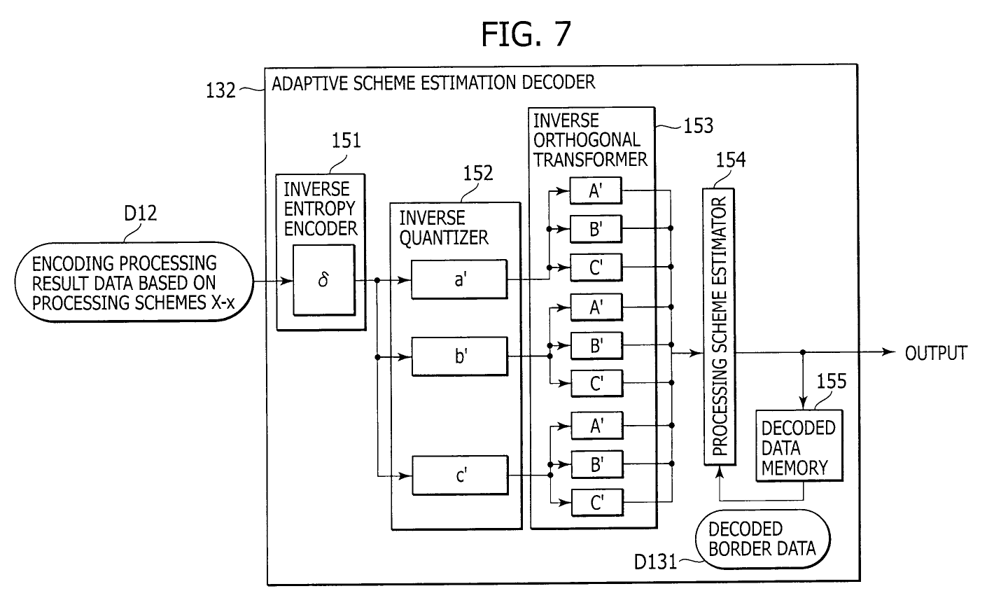

Accordingly, the receiving apparatus 112 according to an embodiment of the present invention differs from the receiving apparatus 12 of FIG. 1 according to the known technique mainly in the following points. Namely, the adaptive decoder 32 according to the known technique has always required associated processing scheme information D11 when performing decoding processing on block-based encoding processing result data D12. Conversely, the adaptive scheme estimation decoder 132 according to an embodiment of the present invention requires no added data such as the processing scheme information D11 being essential in the known technique, at all, when performing decoding processing on block-based encoding processing result data D112. Why such added data is not required at all and a detailed configuration example of the adaptive scheme estimation decoder 132 according to an embodiment of the present invention will be described later with reference to FIG. 7.

Furthermore, details of the adaptive encoder 122 and the adaptive scheme estimation decoder 132 according to an embodiment to which the present invention is applied will be described individually in order of mention.

FIG. 5 shows a functional configuration example of the adaptive encoder 122 according to an embodiment of the present invention is applied, as one example adopted for ease of comparison with the known adaptive encoder 22 of FIG. 2.

The adaptive encoder 122 includes an orthogonal transformer 141, quantization processor 142, entropy decoder 143, and an optimal result selector 144.

The orthogonal transformer 141, quantization processor 142, and entropy decoder 143 have functions and configurations basically similar to those of the orthogonal transformer 41 to the entropy encoder 43 of FIG. 2, respectively.

Accordingly, the adaptive encoder 122 according to the present embodiment differs from the known adaptive encoder 22 of FIG. 2 mainly in the following points.

Namely, the optimal result selector 44 of the known adaptive encoder 22 has consecutively outputted processing scheme information D11 merely being added data to block-based encoding processing result data D12 whenever it outputs the encoding processing result data D12. Conversely, the optimal result selector 144 of the adaptive encoder 122 according to an embodiment of the present invention only outputs block-based encoding processing result data D112, and does not output any added data such as the processing scheme information D11 that has been essentially required in the known technique, whatsoever.

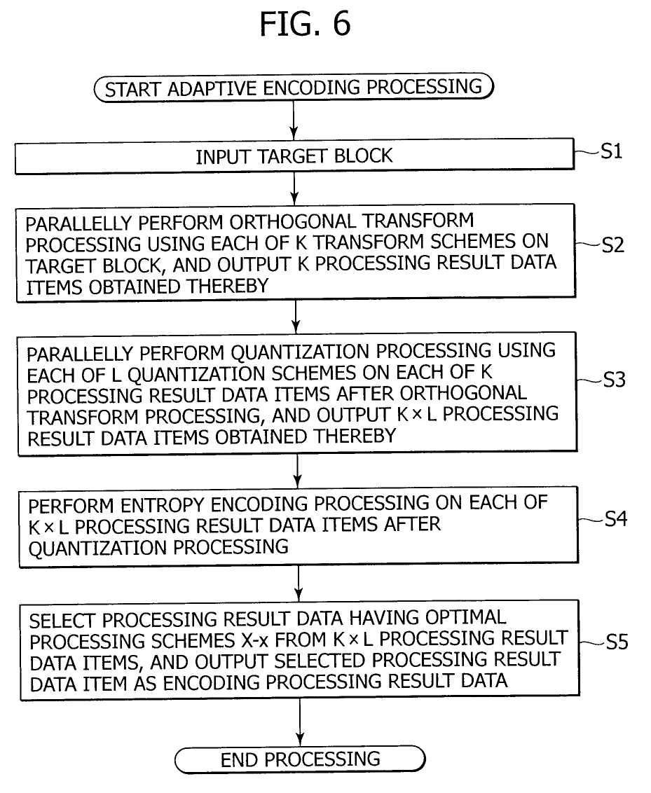

FIG. 6 is a flowchart for illustrating an example of adaptive encoding processing by the adaptive encoder 122 of FIG. 5.

In step S1, the adaptive encoder 122 inputs a block supplied thereto from the processing unit divider 121 as a target block.

In step S2, the orthogonal transformer 141 of the adaptive encoder 122 parallelly performs orthogonal transform processing using K transform schemes (K=three transform schemes A, B, C in the example of FIG. 5) on the target block, and outputs K processing result data items obtained thereby.

In step S3, a quantization processor 142 parallelly performs quantization processing using L quantization schemes (L=three quantization schemes a, b, c in the example of FIG. 5) on each of the K processing result data items after the orthogonal transform processing, and outputs K×L processing result data items obtained thereby.

In step S4, the entropy encoder 143 performs entropy encoding processing on each of the K×L processing result data items after the quantization processing.

As a result, in the example of FIG. 5, K×L (=3×3) processing result data items D112-1 to D112-9 are supplied from the entropy encoder 143 to the optimal result selector 144.

Then, in step S5, the optimal result selector 144 selects a processing result data item exhibiting optimal processing schemes X-x from the K×L processing result data items D112-1 to D112-9, and outputs the selected data item as the encoding processing result data D112.

It is noted that the adaptive encoding processing of FIG. 6 shows processing performed in units of target blocks. In terms of each functional block unit, data sequentially inputted in units of blocks are sequentially subjected to processing corresponding to each function. What is described in this paragraph applies similarly to other later-described flowcharts as well.

FIG. 7 shows a functional configuration example of the adaptive estimation decoder 132 according to an embodiment to which the present invention is applied, as one example adopted for ease of comparison with the known adaptive decoder 32 of FIG. 3.

The adaptive scheme estimation decoder 132 includes an inverse entropy encoder 151, an inverse quantizer 152, inverse orthogonal transformer 153, a processing scheme estimator 154, and a decoded data memory 155.

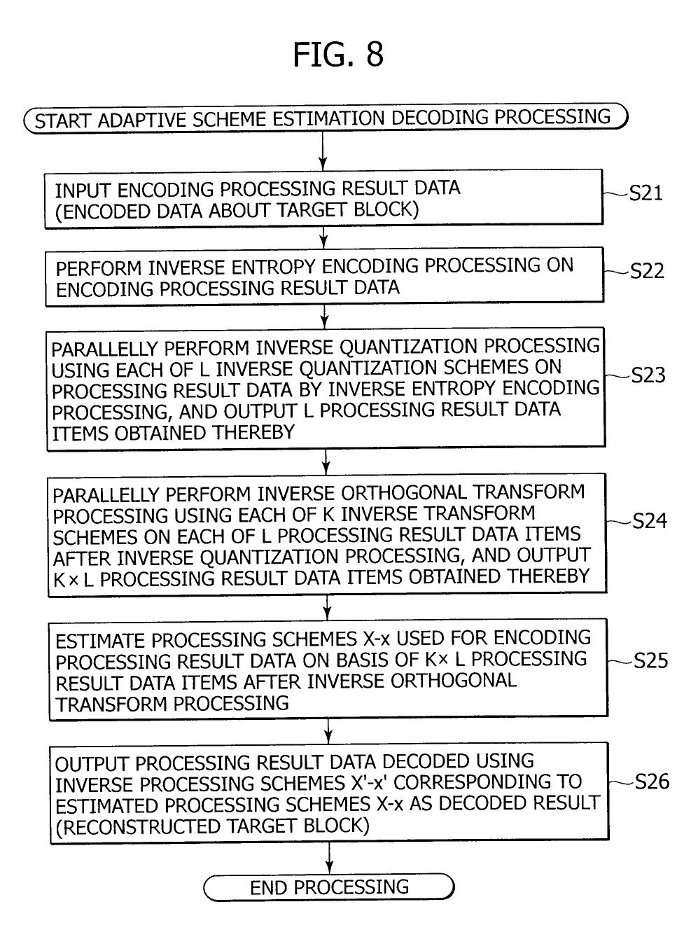

An example of processing (hereinafter called “adaptive scheme estimation decoding processing”) by the adaptive scheme estimation decoder 132 having such a configuration will be described below together with a description of functions of the inverse entropy encoder 151 to the decoded data memory 155. Furthermore, along with the description, FIGS. 8 to 10 will be referred to, as appropriate.

FIG. 8 is a flowchart for illustrating an example of the adaptive scheme estimation decoding processing by the adaptive scheme estimation decoder 132 of FIG. 7.

In step S21, the adaptive scheme estimation decoder 132 inputs the encoding processing result data D112 (encoded data of the target block) supplied thereto from the demultiplexer 131.

In step S22, the inverse entropy encoder 151 of the adaptive scheme estimation decoder 132 performs inverse entropy encoding processing on the encoding processing result data.

In step S23, an inverse quantizer 152 parallelly performs inverse quantization processing using each of L inverse quantization schemes (inverse quantization schemes a′, b′, c′ respectively corresponding to the L=three quantization schemes a, b, c (see FIG. 5) in the example of FIG. 7) on the processing result data obtained by the inverse entropy encoding processing, and outputs L processing result data items obtained thereby.

In step S24, an inverse orthogonal transformer 153 parallelly performs inverse orthogonal transform processing using each of K inverse transform schemes (inverse transform schemes A′, B′, C′ respectively corresponding to the K=three transform schemes A, B, C (see FIG. 5) in the example of FIG. 7) on each of the L processing result data items after the inverse quantization processing, and outputs K×L processing result data items obtained thereby.

In step S25, a processing scheme estimator 154 estimates processing schemes X-x used for the encoding processing result data D112 on the basis of the K×L processing result data items after the inverse orthogonal transform processing.

Then, in step S26, the processing scheme estimator 154 outputs processing result data decoded by using inverse processing schemes X′-x′ corresponding to the estimated processing schemes X-x, as a decoded result (reconstructed target block).

This decoded result (reconstructed target block) is also stored in the decoded data memory 155. The decoded result stored in the decoded data memory 155 is utilized when the estimation processing in step S25 is performed on encoding processing result data D112 on a subsequent another block.

Referring here to FIGS. 9 and 10, a specific example of step S25, i.e., estimation processing on the processing schemes X-x by the processing scheme estimator 154 will be described.

For example, the adaptive scheme estimation decoder 132 is supposed to perform decoding processing on blocks one after another in order indicated by an arrow of FIG. 9. In FIG. 9, black blocks indicate decoded blocks stored in the decoded data memory 155. Also, a gray block is a next block for decoding, i.e., a target block to be reconstructed by steps S25 and S26 or a target block for which processing schemes X-x are estimated by the processing scheme estimator 154.

As shown in FIG. 9, as long as the target block is not a starting block, there exists a boundary plane between the target block and pixels belonging to a decoded block.

In the present embodiment, the target block for decoding is one of the blocks into which the image signal is divided as described above. The image signal has, in general, a property that adjacent pixels are closely correlated. Consequently, the processing scheme estimator 154 can estimate, by taking advantage of this property, what processing result data decoded by which inverse processing schemes is most probable as the target block.

In detail, e.g., the processing scheme estimator 154 performs the following processing as a processing of step S25. Namely, the processing scheme estimator 154 reads data D131 (hereinafter called “decoded boundary data”) on some pixels near a boundary plane among pixels forming a decoded block, from the decoded data memory 155. The processing scheme estimator 154 selects one processing result data item most probable as the target block from the K×L processing result data items after the inverse orthogonal transform processing, using this decoded boundary data D131. Processing schemes corresponding to inverse processing schemes X′-x′ used for this selected processing result data item are the estimated processing schemes X-x.

More specifically, e.g., each block for decoding is supposed to be a 8×8 square block such as shown in FIG. 10. In this case, the adaptive scheme estimation decoder 132 estimates processing schemes X-x by computation of, e.g., Equations (1) to (4) indicated below, using pixel values yi (i takes integers from 1 to 8 in this example) for pixels contiguous to a boundary plane among pixels belonging to a decoded block and pixel values xj (j takes integers from 1 to 64 in this example) of pixels forming a next block (target block) for decoding.

However, the kinds of processing schemes adopted in the adaptive encoding processing are represented as the K×L kinds in the above-mentioned example, whereas in Equations (1) to (4), they are represented as N kinds. In this case, one may assume that N=K×L. Also, in Equations (1) to (4), “n” indicates any of 1 to N. Namely, xₖ(n) indicates a pixel value for a pixel in a block for which a processing scheme n is used. In other words, a pixel value for a pixel in a block obtained as a result of decoding processing by an inverse processing scheme n′ corresponding to the processing scheme n equals xₖ(n).

Furthermore, “iₘ” in the last Equation (4) represents one of the estimated processing schemes X-x.

$$\begin{matrix}diff ( n ) = {\sum }_{k = 1}^{8} {( {x}_{k} ( n ) - {y}_{k} )}^{2} + {\sum }_{k = 1}^{8} {( {x}_{8 ( k - 1 ) + 1} ( n ) - {y}_{k + 8} )}^{2} & ( 1 ) \\ act ( n ) = {\sum }_{h = 0}^{1} {\sum }_{i = 0}^{1} {\sum }_{l = 2}^{7} {\sum }_{k = 2}^{7} {( {x}_{8 ( k + 2 h - 2 ) + l + 2 i - 1} ( n ) - {x}_{8 ( k - 1 ) + l} ( n ) )}^{2} & ( 2 ) \\ ω ( n ) = diff ( n ) + λ \cdot act ( n ) & ( 3 ) \\ {i}_{m} = {n}_{min} \vert ω ( {n}_{min} ) \leq ω ( n ) & ( 4 )\end{matrix}$$

Here, diff(n) in Equation (1) represents a correlation between pixels along a boundary plane of blocks, whereas act(n) in Equation (2) is a value representing a correlation between pixels within a target block to be decoded.

When ω(n) using an appropriate weight coefficient is defined as their relative quantity as in Equation (3), a processing scheme n that minimizes this ω(n) represents one of the estimated processing schemes X-x as shown by Equation (4).

By adopting such a technique, it becomes possible to reconstruct a target block only from encoding processing result data D112 even in the absence of added information such as processing scheme information D11 specifying the processing schemes X-x.

In more correctly, the most probable one of N target block candidates (N=K×L processing result data items from the inverse orthogonal transformer 153) respectively reconstructed by the N kinds of inverse processing schemes is estimated as the target block. Accordingly, the possibility is not completely excluded that processing schemes different from those used for the target block are obtained as an estimation result. However, if erroneous processing schemes is estimated, according to an algorithm of Equations (1) to (4) described above, it is a block formed of pixels having a high level of similarity to pixels near the boundary plane that is estimated as the target block. Accordingly, when image data containing such a block is displayed as video, the video is not perceived by the eyes of a user as image quality degradation. This is another feature provided by the technique.

It is noted that the algorithm of Equations (1) to (4) described above are based on the assumption that the “pixels near a boundary plane” are correct pixels. Consequently, since, e.g., a starting block has no boundary planes, it is virtually difficult to apply the algorithm of Equations (1) to (4) described above. Furthermore, when the “pixels near a boundary plane” are erroneous pixels, e.g., pixels decoded by inverse processing schemes different from those used in the encoding processing, if the algorithm of Equations (1) to (4) described above are applied thereto, these pixels are subjected to estimation processing as correct pixels despite the fact that they are the “erroneous pixels near a boundary plane”. Accordingly, a block formed of pixels having a high level of similarity to the “erroneous pixels near a boundary plane” is estimated as the target block.

Under this circumstances, it may be configured to perform encoding processing using preset processing schemes only on a block judged to be important such as a starting block and a block at the beginning of a line, and to forcibly use inverse processing schemes corresponding to the preset processing schemes without using the algorithm of Equations (1) to (4), as long as encoding processing result data obtained by the encoding processing is to be decoded. However, in this case, it is desired that the encoding side and the decoding side share a rule (hereinafter called “processing scheme partial setting rule”) as to which block the preset processing schemes are used for. However, when and how the processing scheme partial setting rule is shared is not limited, but the rule may be reflected during manufacture of each apparatus. Alternatively, the encoding processing side may notify the decoding processing side of the processing scheme partial setting rule at an appropriate timing. Specifically, for example, such a rule may be contained in information such as header information in encoded data.

By adopting the processing scheme partial setting rule this way, for starting blocks and important blocks, processing schemes used for the encoding processing can be specified. Consequently, correct decoding becomes possible. As a result, when the algorithm of Equations (1) to (4) described above are applied to blocks other than these, reliability for the “pixels near a boundary plane” is increased, thereby increasing reliability for decoding results, which is also desired that the image quality is improved.

Furthermore, if one wishes to further increase the reliability for decoding results, it may be configured such that the transmitting apparatus side transmits processing scheme information indicative of processing schemes X-x on encoding processing result data belonging to some of all the blocks. Such a technique is hereinafter called “processing scheme information partial transmission technique”.

When this processing scheme information partial transmission technique is adopted, if compared with the embodiment described above, i.e., if compared with the embodiment in which no processing scheme information is contained in encoded data at all, the volume of information in the encoded data increases by the processing scheme information on some blocks. However, if compared with the known encoded data D21 (FIG. 1), i.e., encoded data D21 always containing processing scheme information D11 for all blocks, it is apparent that the processing scheme information partial transmission technique can reduce the volume of information in the encoded data, and thus it can be said that one of the advantages of embodiments of the present invention are provided thereby.

In other words, when the processing scheme information partial transmission technique is adopted, in terms of an advantage of reducing the volume of information in encoded data, it is possible to provide such an advantage, but in terms of the level of the advantage, the technique may be inferior to cases where no processing scheme information is contained at all. However, in terms of estimation of the processing schemes X-x for a target block, the estimation accuracy is higher than cases where no processing scheme information is contained at all. As a result, higher image quality can be expected.

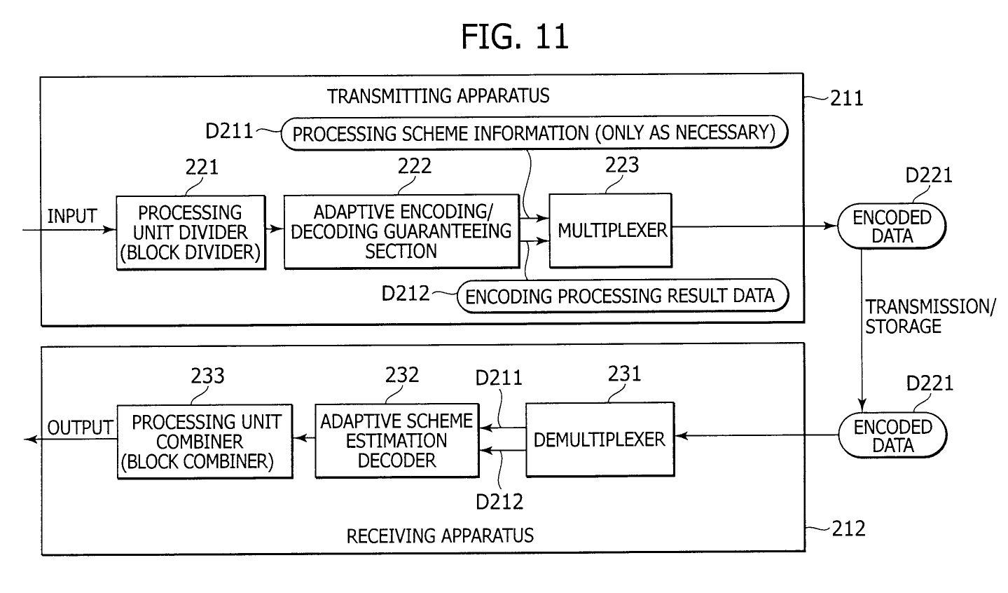

FIG. 11 shows a configuration example of an information processing system to which the processing scheme information partial transmission technique is applied. Namely, FIG. 11 is a functional configuration example according to an embodiment of the information processing system to which the present invention is applied, showing a functional configuration example different from that of FIG. 4.

The information processing system in the example of FIG. 11 includes a transmitting apparatus 211 and a receiving apparatus 212.

The transmitting apparatus 211 includes a processing unit divider 221, an adaptive encoding/decoding guaranteeing section 222, and a multiplexer 223.

The transmitting apparatus 211 performs adaptive encoding processing on an input signal on a predetermined processing unit basis, processes processing unit-based encoding processing result data D212 and processing scheme information D211 on part of the encoding processing result data D212, into stream data, and outputs the stream data as encoded data D221.

While the transmitting apparatus 211 may adopt an arbitrary processing unit, for ease of comparison with the known technique and the example of FIG. 4, a block unit is supposed to be adopted. In this case, the processing unit divider 221 and the multiplexer 223 can have functions and configurations similar to those of the processing unit divider 121 and the multiplexer 123 of FIG. 4, i.e., functions and configurations similar to those of the block divider 21 and the multiplexer 23 of FIG. 1 in the known technique, respectively.

Accordingly, the transmitting apparatus 211 according to an embodiment of the present invention differs from the known transmitting apparatus 11 of FIG. 1 or the transmitting apparatus 111 in the example of FIG. 4 mainly in the following points.

Namely, the adaptive encoder 22 according to the known technique has consecutively outputted processing scheme information D11 merely being added data to block-based encoding processing result data D12 whenever it outputs the encoding processing result data D12. Conversely, the adaptive encoding/decoding guaranteeing section 222 in the example of FIG. 11 outputs processing scheme information D211 only when necessary, i.e., only about part of blocks, not “always” outputting the processing scheme information D211 every time it outputs block-based encoding processing result data D212. It is noted that the adaptive encoder 122 in the example of FIG. 4 does not output any added data such as the processing scheme information at all.

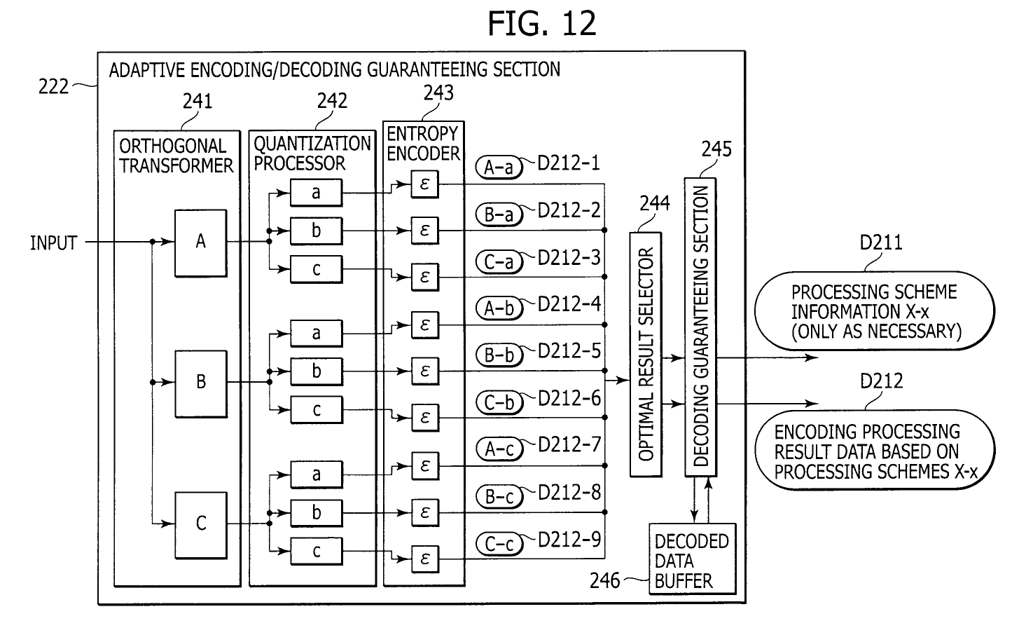

A detailed configuration example of the adaptive encoding/decoding guaranteeing section 222 will be described later with reference to FIG. 12.

As a result of the above, the volume of information decreases in order of the known encoded data D21, the encoded data D221 in the example of FIG. 11, and the encoded data D121 in the example of FIG. 4. Accordingly, in the encoded data D221 in the example of FIG. 11, compression efficiency is increased compared with at least the known encoded data D21.

In order to perform decoding processing in response to such encoded data D221, the receiving apparatus 212 according to an embodiment to which the present invention is applied includes a demultiplexer 231, an adaptive scheme estimation decoder 232, and a processing unit combiner 233.

In the present embodiment, since the block unit is adopted as the processing unit as described above, the demultiplexer 231 and the processing unit combiner 233 can have functions and configurations similar to those of the demultiplexer 131 and the processing unit combiner 133 in the example of FIG. 4, i.e., functions and configurations similar to those of the demultiplexer 31 and the block combiner 33 of FIG. 1 according to the known technique, respectively.

Furthermore, the adaptive scheme estimation decoder 232 may have a function and a configuration basically similar to those of the adaptive scheme estimation decoder 132 in the example of FIG. 4. Namely, the adaptive scheme estimation decoder 232 may have the configuration of, e.g., FIG. 7.

However, only when processing scheme information D211 is inputted together with encoding processing result data D212, the adaptive scheme estimation decoder 232 does not estimate processing schemes X-x on the basis of the algorithm of Equations (1) to (4) described above, but directly specifies the processing schemes X-x from the processing scheme information D211. In this case, data obtained from decoding processing performed on the encoding processing result data D212 on the basis of inverse processing schemes X′-x′ corresponding to the specified processing schemes X-x is outputted from the adaptive scheme estimation decoder 232 as a reconstructed result (reconstructed target block).

By contrast to such an adaptive scheme estimation decoder 232 of the receiving apparatus 212 side, the adaptive encoding/decoding guaranteeing section 222 of the transmitting apparatus 211 side is configured as shown in, e.g., FIG. 12, unlike the example of FIG. 5.

Namely, in an example of FIG. 12, the adaptive encoding/decoding guaranteeing section 222 includes an orthogonal transformer 241 to a decoded data buffer 246.

The orthogonal transformer 241, the quantization processor 242, the entropy encoder 243, and the optimal result selector 244 have functions and configurations basically similar to those of the orthogonal transformer 41, the quantization processor 42, the entropy encoder 43, and the optimal result selector 44 of FIG. 2, respectively.

Accordingly, the adaptive encoding/decoding guaranteeing section 222 of FIG. 12 differs from the adaptive encoder 22 of FIG. 2 according to the known technique mainly in the following points.

Namely, since an output from the optimal result selector 44 of the known adaptive encoder 22 of FIG. 2 is directly used as a final output from the adaptive encoder 22, processing scheme information D11 being merely added data to block-based encoding processing result data D12 has consecutively been outputted whenever the encoding processing result data D12 is outputted.

Conversely, an output from the optimal result selector 244 of the adaptive encoding/decoding guaranteeing section 222 of FIG. 12 is temporarily supplied to a decoding guaranteeing section 245, without being used as a final output from the adaptive encoding/decoding guaranteeing section 222.

The decoding guaranteeing section 254 has a function basically similar to that of the adaptive scheme estimation decoder 132 of FIG. 7. Namely, the decoding guaranteeing section 245 tries local decoding on the encoding processing result data D212 using decoding schemes similar to those of the adaptive scheme estimation decoder 132 of FIG. 7, without using processing scheme information D211, and judges whether the trial result is a correct decoding result, i.e., whether a correct target block is reconstructed, so that it is judged the encoding processing result data D212 is decodable.

In order to realize processing which is the “local decoding on the encoding processing result data D212 using decoding schemes similar to those of the adaptive scheme estimation decoder 132 of FIG. 7”, the decoded data buffer 246 having a function and a configuration basically similar to those of the decoded data memory 155 of FIG. 7 is provided in the adaptive encoding/decoding guaranteeing section 222.

The decoding guaranteeing section 245 outputs only the encoding processing result data D212 when it is judged that the encoding processing result data D212 is decodable. Conversely, the decoding guaranteeing section 245 outputs both the encoding processing result data D212 and processing scheme information D211 associated therewith when it is judged that the encoding processing result data D212 is undecodable.

Namely, the adaptive encoding/decoding guaranteeing section 222 of FIG. 12 outputs both the encoding processing result data D212 and the processing scheme information D211 only for a block judged to be undecodable, and for any other block, outputs only the encoding processing result data D212.

As a result, even in the encoded data D221 finally outputted from the transmitting apparatus 211 of FIG. 11, the processing scheme information D211 is contained only for blocks judged to be undecodable, but is not contained at all for the other blocks. Accordingly, compared with encoded data D21 (FIG. 1), i.e., the encoded data D21 always containing the processing scheme information D11 for all blocks, it is understood that the volume of information is reduced.

Furthermore, for the blocks judged to be undecodable, the processing scheme information D211 is supplied to the adaptive scheme estimation decoder 232 of FIG. 11, so that it is expected to substantially provide complete reconstruction of all blocks by the adaptive scheme estimation decoder 232.

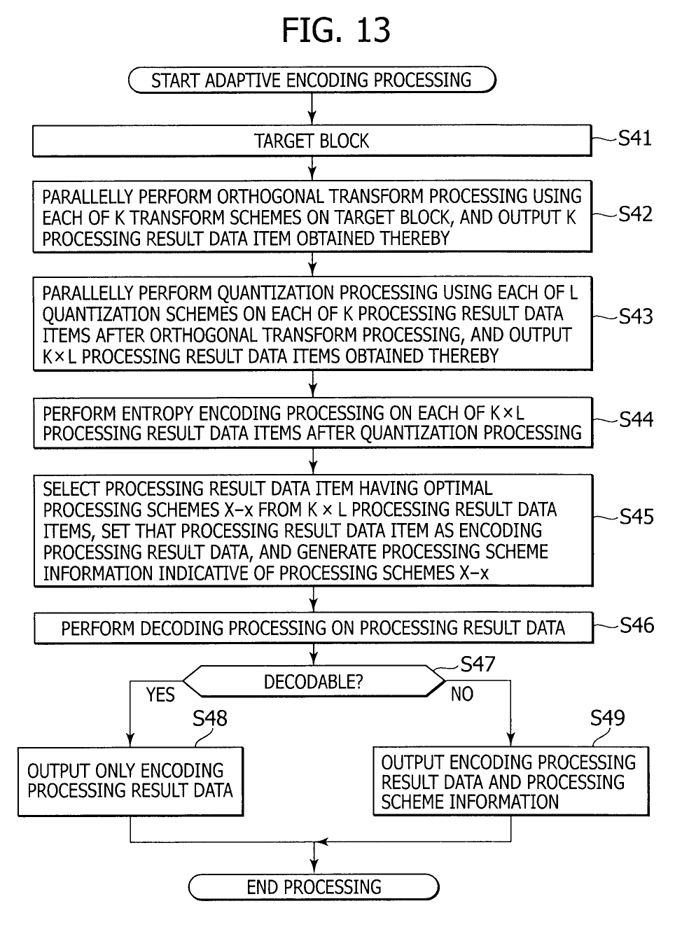

FIG. 13 is a flowchart for illustrating an example of the adaptive encoding processing by the adaptive encoding/decoding guaranteeing section 222 of FIG. 12.

Since steps S41 to S44 are basically similar to steps S1 to S4 of FIG. 6, their description is omitted here.

In step S45, the optimal result selector 244 selects a processing result data item exhibiting the optimal processing schemes X-x from K×L processing result data items D212-1 to D212-9, and sets the selected processing result data as encoding processing result data D212, and also generates processing scheme information D211 indicative of the processing schemes X-x.

In step S46, the decoding guaranteeing section 245 judges whether the encoding processing result data D212 is decodable.

If it is judged that the data is decodable in step S46, the decoding guaranteeing section 245 outputs only the encoding processing result data D212.

On the other hand, if it is judged that the data is undecodable in step S46, the decoding guaranteeing section 245 outputs both the encoding processing result data D212 and the processing scheme information D211.

As described above, in embodiments of the present invention, processing scheme information is not supplied to the decoding side at least for all blocks, so that it is desired that the decoding side estimates processing schemes when reconstructing blocks for which the processing scheme information is not supplied, i.e., when performing decoding processing on their encoding processing result data.

An estimation technique itself for the processing schemes is not particularly limited. A technique compliant with the algorithm of Equations (1) to (4) has been indicated as one example.

However, when an estimation technique (hereinafter called “decoded-data using estimation technique”) using the property of decoded data, such as a technique compliant with the algorithm of Equations (1) to (4) described above is adopted, the estimation may fail in some cases when decoded data contains many errors, as described above.

In other words, in the decoded-data using estimation technique, in order to prevent (or to minimize) estimation failure, there exist important blocks to be correctly reconstructed since the technique uses the property of decoded data. For example, once a starting block cannot be reconstructed correctly, estimation inaccuracy for subsequent blocks aggravates cumulatively. Consequently, the starting block is the most important block. For similar reasons, it can be said that a block at the beginning of a line of a frame and the like are also important blocks.

Here, it is considered to perform encrypting processing only on such an important block during encoding processing. In this case, unless an important block is deciphered (decoded), it is difficult to estimate processing schemes used for encoding the rest of the blocks (the possibility of estimation failure rapidly increases), so that decoding becomes difficult. This means that if only an important block is encrypted, an advantage can be obtained for the rest of the blocks as if the rest of the blocks are also encrypted.

Furthermore, as described above, there is no decoded data at all for the starting block. Accordingly, the decoding side fails in estimation when not knowing the processing scheme partial setting rule described above. Namely, the processing scheme partial setting rule is very important information to the decoding side, and if not knowing the rule, the decoding side needs to have the information contained in encoded data or the like. Thus, together with the important block or in place thereof, it may be configured to encrypt the important information such as the processing scheme partial setting rule. Even in this case also, an advantage is obtained for blocks not subjected to the encryption processing after all, as if the blocks are also subjected to the encryption processing.

In summary, when the encoding side supplies encoded data to the decoding side adopting the decoded-data using estimation technique, if the decoding side is requesting encrypted encoded data, the encoding side does not particularly need to encipher all blocks, but may adopt a technique (hereinafter called “partial encryption technique”) for encrypting only important information (including an important block) for correct decoding processing. In this case, there is no need to encrypt the whole processing data, and thus encrypting volume can be reduced by such eliminated encryption.

Specifically, for example, when the partial encryption technique is applied to the information processing system in the example of FIG. 4, a functional configuration example is constructed as shown in FIG. 14.

Namely, the transmitting apparatus 111 further includes an encryption section 301 subsequent stage of the adaptive encoder 122 and preceding stage of the multiplexer 123, with respect to the configuration in the example of FIG. 4.

The encrypting section 301 encrypts, only when having encoding processing result data D112 about an important block inputted thereto, that encoding processing result data D112, and prohibits encrypting in cases other than this. The encrypting section 301 may be configured to encrypt the desired information such as the processing scheme partial setting rule, together with or in place of the encoding processing result data D112 on the important block.

Furthermore, the receiving apparatus 112 is further provided with a decryption section 302 subsequent stage of the demultiplexer 131 and preceding stage of the adaptive scheme estimation decoder 132, with respect to the configuration in the example of FIG. 4.

The decryption section 302 decrypts, when the encrypted data is supplied thereto from the demultiplexer 131, encoding processing result data D112 and the desired information such as the processing scheme partial setting rule, from that encrypted data, and prohibits decrypting in cases other than that.

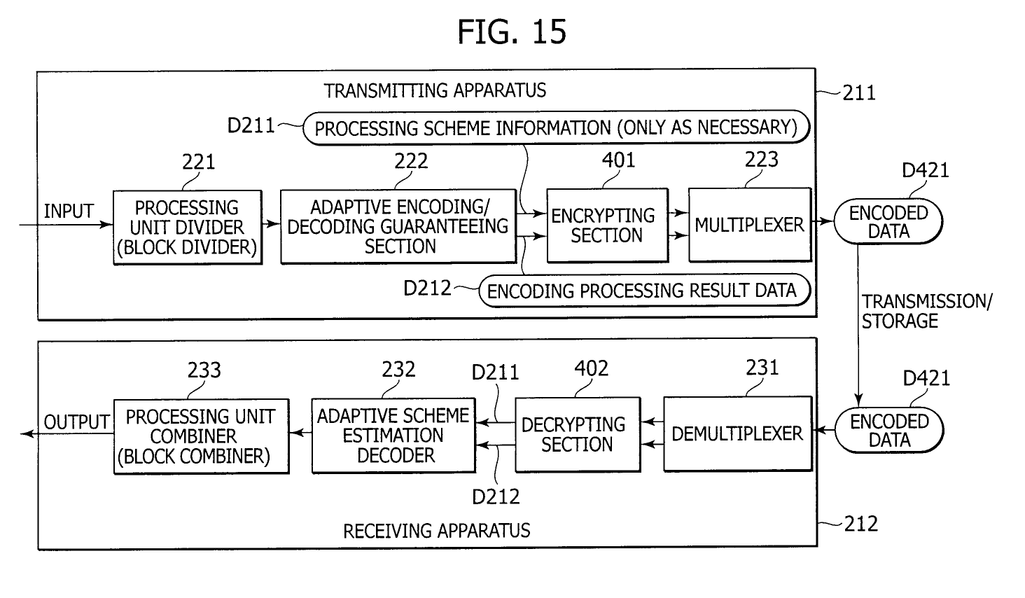

Furthermore, for example, when the partial encrypting technique is applied to the information processing system in the example of FIG. 11, a functional configuration example is constructed as shown in FIG. 15.

Namely, the transmitting apparatus 211 further includes an encrypting section 401 subsequent stage of the adaptive encoding/decoding guaranteeing section 222 and preceding stage of the multiplexer 223, with respect to the configuration in the example of FIG. 11.

The encryption section 401 encrypts, only when having encoding processing result data D212 on an important block inputted thereto, at least one of that encoding processing result data D212 and processing scheme information D211, and prohibits encrypting in cases other than that. The encrypting section 401 may be configured to encrypt the desired information such as the processing scheme partial setting rule, together with or in place of the encoding processing result data D212 on the important block or the processing scheme information D211.

Furthermore, the receiving apparatus 212 further includes a decryption section 402 subsequent stage of the demultiplexer 231 and preceding stage of the adaptive scheme estimation decoder 232, with respect to the configuration in the example of FIG. 11.

The decryption section 402 decrypts, when the encrypted data is supplied thereto from the demultiplexer 231, encoding processing result data D212, processing scheme information D211, and desired information such as the processing scheme partial setting rule, from the encrypted data, and prohibits decrypting in cases other than that.

By the way, a series of processing including the listed processing described above may be performed by hardware or by software as well.

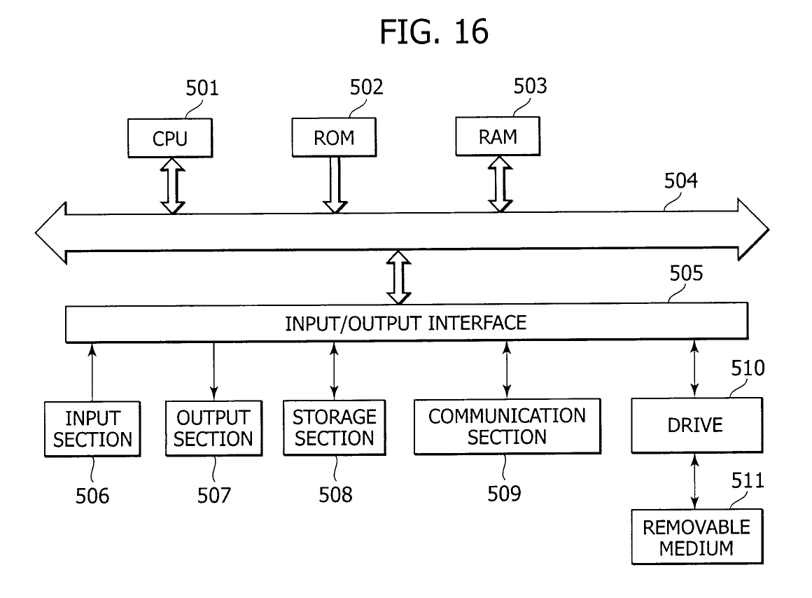

When the series of processing described above is performed by software, an information processing apparatus according to an embodiment to which the present invention is applied can be implemented by a computer shown in, e.g., FIG. 16.

In FIG. 16, a CPU (Central Processing Unit) 501 performs various processing according to a program recorded on a ROM (Read Only Memory) 502, or a program loaded to a RAM (Random Access Memory) 503 from a storage section 508. The RAM 503 stores data necessary for the CPU 501 to perform the various processing.

The CPU 501, ROM 502, and RAM 503 are interconnected via a bus 504. An input/output interface 505 is also connected to this bus 504.

For the input/output interface 505, an input section 506 including a keyboard and a mouse, an output section 507 including a display, the storage section 508 including a hard disk, and a communication section 509 including a modem and a terminal adapter are connected. The communication section 509 controls communication with other apparatuses (not shown) over networks including the Internet.

In the input/output interface 505, a drive 510 is also connected as necessary, to which a removable medium 511, such as a magnetic disk, an optical disc, a magneto-optical disk, or a semiconductor memory, is attached whenever appropriate. A computer program read from such a removable medium is installed in the storage section 508 whenever necessary.

If the series of processing is executed by software, a program forming the software is installed in a computer, such as a computer incorporated into dedicated hardware, or, e.g., a general-purpose personal computer capable of executing various functions by installing various programs therein, over a network or a recording medium.

The recording medium containing such a program includes, as shown in FIG. 16, not only the removable medium (package medium) 511 such as a magnetic disk (including a floppy disk), an optical disc (including a CD-ROM (Compact Disk-Read Only Memory)) and a DVD (Digital Versatile Disc)), a magneto-optical disk (including an MD (Mini-Disk)), or a semiconductor memory, which is distributed to provide a user with the program and on which the program has been recorded, separately from the apparatus body, but also the ROM 502 or the hard disk included in the storage section 508, which is provided to the user as incorporated into the apparatus body and on which the program has been recorded.

It is noted that in the present specification, steps describing the program recorded on the recording medium include processing executed not only time-sequentially in order of the steps described, but may also include processing executed parallelly or individually, not necessarily executed time-sequentially.

In addition, the system used in the present specification represents the whole apparatus formed of a plurality of apparatuses and processing sections.

Furthermore, while the above-described embodiments are merely one example in which the present invention is applied to block encoding, the present invention is not limited to the above-described embodiments, but may be implemented as various other embodiments.

For example, in the input signal dividing technique, the mode, size, and the like of division are not particularly limited. Hence, as long as any correlation is generally established among data along a boundary plane into which the input signal is divided by such various dividing techniques, the present invention can be applied to such data.

Furthermore, for example, for block-based adaptive processing also, the present invention is not particularly limited to the above-described adaptive encoding processing, but may be applicable to arbitrary processing other than the orthogonal transform processing and the like.

What is claimed is:

1. An information processing system comprising:
a first information processing apparatus; and
a second information processing apparatus,
wherein the first information processing apparatus:
performs processing on each of a plurality of local area data using a processing scheme, respectively, the plurality of local area data being obtained by dividing an input signal, the processing scheme being selected from a plurality of processing schemes, respectively, and
outputs an output signal containing a plurality of local area processing result data obtained as each the processed result and not containing information on the processing schemes used to each of the plurality of local area processing result data, and
wherein the second information processing apparatus:
extracts the plurality of local area processing result data from the output signal of the first information processing apparatus,
estimates each of the processing schemes used for the processing on each of the plurality of extracted local area processing result data, and reconstructs each of the plurality of local area data corresponding thereto on the basis of the estimated processing schemes, respectively, and
reconstructs the input signal of the first information processing apparatus by combining each the reconstructed local area data.

2. An information processing method for an information processing system including a first information processing apparatus and a second information processing apparatus, the method comprising the steps of:
in the first information processing apparatus,
performing processing on a plurality of local area data using a processing scheme, respectively, the plurality of local area data being obtained by dividing an input signal, the processing scheme being selected from a plurality of processing schemes, respectively; and
outputting an output signal containing a plurality of local area processing result data obtained as each the processed result and not containing information on the processing schemes used to each of the plurality of local area processing result data, and
in the second information processing apparatus,
extracting the plurality of local area processing result data from the output signal of the first information processing apparatus,
estimating each of the processing schemes used for the processing on each of the plurality of extracted local area processing result data, and reconstructing each of the plurality of local area data corresponding thereto on the basis of the estimated processing schemes, respectively, and
reconstructing the input signal to the first information processing apparatus by combining the plurality of reconstructed local area data.

3. An information processing apparatus, comprising:
means for performing processing on each of a plurality of local area data using a processing scheme, respectively, the plurality of local area data being obtained by dividing an input signal, the processing scheme being selected from a plurality of processing scheme, respectively; and
means for generating an output signal containing a plurality of local area processing result data obtained as each the processed result by the processing performing means and not containing information on the processing schemes used to each of the plurality of local area processing result data.

4. The information processing apparatus according to claim 3, wherein the local area data has a property establishing a predetermined correlation at a boundary surface with another local area data.

5. The information processing apparatus according to claim 4, wherein:
if the plurality of local area data is reconstructed from the output signal of the information processing apparatus utilizing the property, in another information processing apparatus,
the information processing apparatus further includes encryption means for encrypting only a predetermined part of all data necessary for reconstructing the plurality of local area data in the another information processing apparatus.

6. An information processing method, the method comprising the steps of:
performing processing on each of a plurality of local area data using a processing scheme, respectively, the plurality of local area data being obtained by dividing an input signal, the processing scheme being selected from a plurality of processing schemes, respectively; and
generating an output signal containing a plurality of local area processing result data obtained as each the processed result and not containing information on the processing schemes used on each of the plurality of local area processing result data.

7. A program for causing a computer that separates and divides an input signal into a plurality of local area data, and performs processing on each of the plurality of local area data, to execute control processing comprising the steps of:
performing processing on each of the plurality of local area data using a processing scheme, respectively, the processing scheme being selected from a plurality of processing schemes, respectively; and
generating an output signal containing a plurality of local area processing result data obtained as each the processed result and not containing information on the processing schemes used to each of the plurality of local area processing result data.

8. An information processing apparatus which reconstructs an input signal from an output signal of an another information processing apparatus, the input signal being reconstructed from an output signal of the another information processing apparatus, comprising:
if the another information processing apparatus:
performs processing on each of a plurality of local area data using a processing scheme,
respectively, the plurality of local area data being obtained by dividing an input signal,
the processing scheme being selected from a plurality of processing schemes, respectively, and
outputs an output signal containing a plurality of local area processing result data as each the processed result and not containing information on the processing schemes used to each of the plurality of local area processing result data,
extracting means for extracting the plurality of local area processing result data from the output signal of the another information processing apparatus;
local area reconstructing means for estimating each of the processing schemes used for the processing on each of the plurality of local area processing result data extracted by the extracting means, and
reconstructing each of the plurality of local area data corresponding thereto on the basis of the estimated processing schemes, respectively; and
combining means for combining the local area data each reconstructed by the local area reconstructing means to reconstruct the input signal of the another information processing apparatus.

9. The information processing apparatus according to claim 8, wherein:
the local area data has a property establishing a predetermined correlation at a boundary plane with another local area data, and
the local area reconstructing means estimates, by using the property, the processing scheme used for the local area processing result data to be processed.

10. The information processing apparatus according to claim 8, wherein:
if the another information processing apparatus further encrypts only a predetermined part of all data necessary for reconstructing the plurality of local area data in the information processing apparatus, and transmits the output signal containing the encrypted data obtained thereby,
the extracting means further extracts the encrypted data from the output signal of the another information processing apparatus,
the information processing apparatus further includes decryption means for decrypting the encrypted data, and
the local area reconstructing means further uses data obtained as a result of the decryption by the decryption means, in the estimation processing of the processing schemes.

11. An information processing method for reconstructing an input signal of an information processing apparatus from an output signal of an another information processing apparatus, the input signal being reconstructed from an output signal of the another information processing apparatus, comprising the steps of:
if the another information processing apparatus:
performs processing on a plurality of local area data using a processing scheme, respectively, the plurality of local area data being obtained by dividing an input signal, the processing scheme being selected from a plurality of processing scheme, respectively, and
outputs an output signal containing a plurality of local area processing result data obtained as each the processed result and not containing information on the processing schemes used to each of the plurality of local area processing result data,
extracting the plurality of local area processing result data from the output signal of the another information processing apparatus;
estimating each of the processing schemes used for the processing on each of the plurality of extracted local area processing result data, and reconstructing each of the plurality of local area data corresponding thereto on the basis of the estimated processing schemes; and
reconstructing the input signal of the another information processing apparatus by combining the plurality of reconstructed local area data.

12. A program executed by a computer that executes processing on reconstructing an input signal of an information processing apparatus from an output signal from the information processing apparatus, wherein the computer executes control processing comprising the steps of:
if the information processing apparatus:
performs processing on each of the plurality of local area data using a processing scheme, respectively, the processing scheme being selected from a plurality of processing schemes, respectively; and
generating an output signal containing a plurality of local area processing result data obtained as each the processed result and not containing information on the processing schemes used to each of the plurality of local area processing result data,
extracting the plurality of local area processing result data from the output signal of the information processing apparatus;
estimating each of the processing schemes used for the processing on each of the plurality of extracted local area processing result data, and reconstructing each of the plurality of local area data corresponding thereto on the basis of the estimated processing schemes; and
reconstructing the input signal of the information processing apparatus by combining the each the reconstructed local area data.

13. An information processing apparatus, comprising:
a processor configured to perform processing on each of a plurality of local area data using a processing scheme, respectively, the plurality of local area data being obtained by dividing an input signal, the processing scheme being selected from a plurality of processing scheme, respectively; and
a generator configured to generate an output signal containing a plurality of local area processing result data obtained as each the processed result by the processing performing means and not containing information on the processing schemes used to each of the plurality of local area processing result data.

14. An information processing apparatus which reconstructs an input signal from an output signal of an another information processing apparatus, the input signal being reconstructed from an output signal of the another information processing apparatus, comprising:
if the another information processing apparatus:
performs processing on each of a plurality of local area data using a processing scheme,
respectively, the plurality of local area data being obtained by dividing an input signal, the processing scheme being selected from a plurality of processing schemes, respectively, and
outputs an output signal containing a plurality of local area processing result data as each the processed result and not containing information on the processing schemes used to each of the plurality of local area processing result data,
an extracting section configured to extract the plurality of local area processing result data from the output signal of the another information processing apparatus;
a local area reconstructing section configured to estimate each of the processing schemes used for the processing on each of the plurality of local area processing result data extracted by the extracting means, and reconstruct each of the plurality of local area data corresponding thereto on the basis of the estimated processing schemes, respectively; and
a combining section configured to combine the local area data each reconstructed by the local area reconstructing means to reconstruct the input signal of the another information processing apparatus.
